(19) United States
(12) Patent Application Publication
(10) Pub. No.: US 2026/0272017 A1
(43) Pub. Date: Sep. 17, 2026

(54) AEROSOL GENERATOR

(71) Applicant: Nicoventures Trading Limited, London (GB)

(72) Inventors: Mark POTTER, London (GB); Richard HEPWORTH, London (GB); Tom WOODMAN, London (GB); Steven SCHENNUM, Naperville, IL (US); Damyn MUSGRAVE, London (GB)

(21) Appl. No.: 19/168,308

(22) PCT Filed: Mar. 28, 2024
(86) PCT No.: PCT/US2024/022043

§ 371 Date: Sep. 23, 2025

Related U.S. Application Data
(63) Continuation of application No. 18/465,589, filed on Sep. 12, 2023, now abandoned.

(30) Foreign Application Priority Data
Mar. 29, 2023 (GB) 2304638.6
Nov. 20, 2023 (GB) 2317713.2

(51) Int. Cl. A24F 40/46; A24F 40/20; A24F 40/70

(52) U.S. Cl. CPC A24F 40/46; A24F 40/20; A24F 40/70

(57) ABSTRACT

An aerosol generator of an article for an aerosol provision device is provided. The aerosol generator is elongated along a longitudinal direction. The aerosol generator comprises aerosol generating material and a resistive heating layer. The resistive heating layer comprises a first resistive heating element configured to heat at least a first portion of the aerosol generating material to generate an aerosol and a second resistive heating element configured to heat at least a second portion of the aerosol generating material to generate another aerosol. The aerosol generating material being on the resistive heating layer. The aerosol generator further comprises at least one first type of electrical contacts and at least one second type of electrical contact. The first resistive heating element is at least a portion of an electrically conductive path between one of the first type of electrical contacts and the or one of the second type of electrical contacts. The second resistive heating element is at least a portion of an electrically conductive path between another one of the first type of electrical contacts and the or another one of the second type of electrical contacts. The first resistive heating element is displaced from the second resistive heating elements in a lateral direction perpendicular to the longitudinal direction.

### CROSS-REFERENCE TO RELATED APPLICATIONS

This present application is a National Phase entry of PCT Application No. PCT/US2024/022043, filed 28 Mar. 2024, which claims priority from Great Britain Application No. 2304638.6, filed 29 Mar. 2023, and which claims priority from U.S. application Ser. No. 18/465,589, filed 12 Sep. 2023, and which claims priority from Great Britain Application No. 2317713.2, filed 20 Nov. 2023, each of which are fully incorporated herein by reference in their entireties.

### TECHNICAL FIELD

The present invention relates to an aerosol generator of an article for an aerosol provision device. The present invention also relates to an article for an aerosol provision device, an aerosol provision system, a method of forming an aerosol generator of an article for an aerosol provision device, and a blank for forming an aerosol generator of an article for an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium.

### SUMMARY

According to an aspect, there is provided an aerosol generator of an article for an aerosol provision device. The aerosol generator is elongated along a longitudinal direction. The aerosol generator comprises aerosol generating material and a resistive heating layer. The resistive heating layer comprises a first resistive heating element configured to heat at least a first portion of the aerosol generating material to generate an aerosol and a second resistive heating element configured to heat at least a second portion of the aerosol generating material to generate another aerosol. The aerosol generating material is on the resistive heating layer. The aerosol generator further comprises at least one first type of electrical contacts and at least one second type of electrical contact. The first resistive heating element is at least a portion of an electrically conductive path between one of the first type of electrical contacts and the or one of the second type of electrical contacts. The second resistive heating element is at least a portion of an electrically conductive path between another one of the first type of electrical contacts and the or another one of the second type of electrical contacts. The first resistive heating element is displaced from the second resistive heating elements in a lateral direction perpendicular to the longitudinal direction.

In an embodiment of any of the above, the at least one first type of electrical contacts may be positioned at a longitudinal end of the aerosol generator.

In an embodiment of any of the above, the at least one second type of electrical contact may be positioned at a longitudinal end of the aerosol generator.

In an embodiment of any of the above, the first and/or second resistive heating element may have a serpentine shape.

In an embodiment of any of the above, the serpentine shape may comprise a portion that winds back and forth in the lateral direction.

In an embodiment of any of the above, the first and second resistive heating elements at least partially nest with each other.

In an embodiment of any of the above, the first and second resistive heating elements at least partially overlap in the longitudinal and/or lateral direction.

In an embodiment of any of the above, the first resistive heating element and the second resistive heating element are interlaced with each other.

In an embodiment of any of the above, the aerosol generator is tubular.

In an embodiment of any of the above, the aerosol generator is rolled or twisted so as to form a tubular shape.

In an embodiment of any of the above, at least one of the first and second resistive heating elements follows a helical path.

In an embodiment of any of the above, the aerosol generator comprises an aerosol generating layer incorporating the aerosol generating material. In an embodiment of any of the above, the aerosol generating layer is on the resistive heating layer.

In an embodiment of any of the above, the first and second resistive heating elements may be separate from each other enabling individual activation of each of the first and second resistive heating elements.

In an embodiment of any of the above, the first and second resistive heating elements may be directly adjacent to each other.

In an embodiment of any of the above, the at least one second type of electrical contact may be a single second type of electrical contact common to both the first and second resistive heating elements.

In an embodiment of any of the above, the at least one second type of electrical contact may be a plurality of the second type of electrical contacts.

In an embodiment of any of the above, the first and/or second resistive heating elements may extend along a full length of the aerosol generating material in the longitudinal direction.

In an embodiment of any of the above, the aerosol generator may further comprise a plurality of contact pads. The plurality of contact pads may comprise a first end contact pad electrically coupled to the first type of electrical contact that is closer in a lateral direction to a first longitudinal edge than any of the other first type of electrical contacts, one or more intermediate contact pads, each of which is electrically coupled to both: one of the first and second type of electrical contact of one of resistive heating elements, and one of the first and second type of electric contact of an adjacent resistive heating element, and a second end contact pad electrically coupled to the second type of electrical contact that is closer in a lateral direction to a second longitudinal edge than any of the other second type of electrical contacts.

In an embodiment of any of the above, each of the one or more intermediate contact pads may be electrically coupled to both a first type of electrical contact of one of resistive heating elements and a second type of electric contact of an adjacent resistive heating element.

In an embodiment of any of the above, each of the one or more intermediate contact pads may be electrically coupled to both a first type of electrical contact of one of resistive heating elements and a first type of electric contact of an adjacent resistive heating element.

In an embodiment of any of the above, each of the second type of electrical contacts may be positioned between two first type of electrical contacts and/or each of the first type of electrical contacts may be positioned between two second type of electrical contacts.

In an embodiment of any of the above, each of the second type of electrical contacts may be positioned between another second type of electrical contacts and a first type of electrical contact and/or each of the first type of electrical contacts may be positioned between another first type of electrical contacts and a second type of electrical contact.

In an embodiment of any of the above, the at least one first type of electrical contacts comprises a plurality of electrical contacts.

According to an aspect there is provided an aerosol generating system. The aerosol generating system comprises an article comprising the aerosol generator as described above and an aerosol provision device configured to receive the article and use the article to generate aerosol.

According to an aspect there is provided an aerosol generator of an article for an aerosol provision device. The aerosol generator is elongated along a longitudinal direction. The aerosol generator comprises comprising aerosol generating material, a resistive heating layer comprising a resistive heating element configured to heat at least a portion of the aerosol generating material to generate an aerosol, the aerosol generating material being on the resistive heating layer, a first type of electrical contact, and a second type of electrical contact. The resistive heating element is at least a portion of an electrically conductive path between the first type of electrical contact and the second type of electrical contact. The resistive heating element extends along a full length of a heating section of the aerosol generator in the longitudinal direction.

In an embodiment of any of the above, the aerosol generator comprises an aerosol generating layer incorporating the aerosol generating material. In an embodiment of any of the above, the aerosol generating layer is on the resistive heating layer.

According to an aspect there is provided an aerosol generator of an article for an aerosol provision device. The aerosol generator is elongated along a longitudinal direction. The aerosol generator comprises aerosol generating material, a resistive heating layer comprising a resistive heating element configured to heat at least a portion of the aerosol generating material to generate an aerosol, the aerosol generating material being on the resistive heating layer, a first type of electrical contact, and a second type of electrical contact. The resistive heating element is at least a portion of an electrically conductive path between the first type of electrical contact and the second type of electrical contact. The electrically conductive path extends back and forth along the longitudinal direction.

In an embodiment of any of the above, the aerosol generator comprises an aerosol generating layer incorporating the aerosol generating material. In an embodiment of any of the above, the aerosol generating layer is on the resistive heating layer.

According to an aspect there is provided a method of manufacturing an aerosol generator of an article for an aerosol provision device. The aerosol generator is elongated along a longitudinal direction. The method comprises moving a resistive heating layer along a longitudinal direction and forming on the resistive heating layer: a first resistive heating element configured to generate heat, a second resistive heating element configured to generate heat, a plurality of a first type of electrical contacts, and at least one second type of electrical contact. The first resistive heating element is at least a portion of an electrically conductive path between one of the first type of electrical contacts and the or one of the second type of electrical contacts. The second resistive heating element is at least a portion of an electrically conductive path between another one of the first type of electrical contacts and the or another one of the second type of electrical contacts. The first and second resistive heating elements are displaced in a lateral direction perpendicular to the longitudinal direction.

In an embodiment of any of the above, the forming step may be performed at least partially at the same time as the moving step.

In an embodiment of any of the above, an exterior of the article has a length, a width perpendicular to the length, and a depth perpendicular to each of the length and the width, wherein the length is greater than or equal to the width, and wherein the width is greater than the depth.

In an embodiment of any of the above, the aerosol generator comprises a support configured to support the resistive heating layer.

In an embodiment of any of the above, the support comprises a support layer.

In an embodiment of any of the above, the support is electrically insulative.

In an embodiment of any of the above, the support comprises at least one of paper and card.

In an embodiment of any of the above, the aerosol generating material is in direct contact with the resistive heating layer. In an embodiment of any of the above, the aerosol generating layer is in direct contact with the resistive heating layer.

In an embodiment of any of the above, the aerosol generating material is in indirect contact with the resistive heating layer. In an embodiment of any of the above, the aerosol generating layer is in indirect contact with the resistive heating layer.

In an embodiment of any of the above, the resistive heating layer and the support layer define a substrate.

In an embodiment of any of the above, the aerosol generator comprises a laminate comprising the resistive heating layer and the support layer.

In an embodiment of any of the above, the laminate comprises the aerosol generating layer.

In an embodiment of any of the above, the support layer comprises a card layer.

In an embodiment of any of the above, the first type of electrical contact is configured to electrically connect with a device electrical connector and the second type of electrical contact is configured to electrically connect with the device electrical connector.

In an embodiment of any of the above, the support defines an exposed contact area of the first type of electrical contact.

In an embodiment of any of the above, wherein the exposed contact area is a first exposed contact area, and the support defines a second exposed contact area of the second type of electrical contact.

In an embodiment of any of the above, the aerosol generating layer is a continuous aerosol generating layer.

In an embodiment of any of the above, the aerosol generating layer is a discontinuous aerosol generating layer.

In an embodiment of any of the above, the aerosol generating layer comprises a plurality of discrete aerosol generating portions.

In an embodiment of any of the above, the resistive heating element is one of a plurality of resistive heating elements.

In an embodiment of any of the above, one of the discrete aerosol generating portions is associated with a corresponding one of the plurality of resistive heating elements.

In an embodiment of any of the above, the aerosol generating layer comprises at least one of dots, strips and patches.

In an embodiment of any of the above, wherein the resistive heating element is a first heating element and the resistive heating layer forms a second resistive heating element, each resistive heating element providing an electrically conductive path for resistive heating of a portion of the aerosol generating material to generate an aerosol at the respective portion of the aerosol generating material.

In an embodiment of any of the above, wherein the resistive heating element is a first heating element and the resistive heating layer forms a second resistive heating element, each resistive heating element providing an electrically conductive path for resistive heating of a portion of the aerosol generating material to generate an aerosol at the respective portion of the aerosol generating layer.

In an embodiment of any of the above, wherein the resistive heating layer forms an array of resistive heating elements comprising at least the first resistive heating element and the second resistive heating element.

In an embodiment of any of the above, wherein each of the first type of electrical contact and the second type of electrical contact are configured to enable an electric current to be individually provided to each of the resistive heating elements.

In an embodiment of any of the above, wherein the aerosol generating layer comprises a film or gel layer comprising the aerosol generating material.

In an embodiment of any of the above, the aerosol generator comprises a plurality of the first type of electrical contact, wherein each of the heating elements comprises a separate first type of electrical contact.

In an embodiment of any of the above, the aerosol generator comprises a plurality of the second type of electrical contacts, wherein each of the resistive heating elements comprises a separate second type of electrical contact.

In an embodiment of any of the above, wherein the aerosol generator comprises a single second type of electrical contact.

In an embodiment of any of the above, wherein the single second type of electrical contact is shared between each of the resistive heating elements.

In an embodiment of any of the above, wherein the resistive heating element is formed by at least one of: cutting the resistive heating layer; chemically etching the resistive heating layer; forming or pressing the resistive heating layer in the substrate; and printing the resistive heating layer.

In an embodiment of any of the above, wherein the resistive heating layer is in the form of a foil.

According to an aspect, there is provided an aerosol generator of an article for an aerosol provision device. The aerosol generator comprises aerosol generating material, a resistive heating layer comprising a resistive heating element configured to heat at least a portion of the aerosol generating material to generate an aerosol, a first type of electrical contact, and a second type of electrical contact. The resistive heating element is at least a portion of an electrically conductive path between the first type of electrical contact and the second type of electrical contact.

In an embodiment of any of the above, the aerosol generator comprises an aerosol generating layer incorporating the aerosol generating material. In an embodiment of any of the above, the aerosol generating layer is on the resistive heating layer.

According to an aspect, there is provided an aerosol provision device configured to receive an aerosol generator or an article for an aerosol provision device of any of the above.

According to an aspect, there is provided an aerosol provision system comprising an aerosol generator or an article for an aerosol provision device of any of the above, and an aerosol provision device of any of the above.

### BRIEF DESCRIPTION OF THE DRAWINGS

Various embodiments will now be described, by way of example only, with reference to the accompanying schematic drawings, in which:

FIG. 1 is a schematic perspective view of an aerosol provision system;

FIG. 2 is a schematic perspective view of an article comprising aerosol generating material of the aerosol provision system of FIG. 1;

FIG. 3 is a schematic perspective view of a first side of an aerosol generator of the article of FIG. 2;

FIG. 4 is a schematic perspective view of part of a second side of the aerosol generator of FIG. 3;

FIG. 5 is a schematic block diagram of an aerosol provision system such as the system shown in FIG. 1;

FIG. 6 is a schematic partially exploded perspective view of the article of FIG. 2, with an aerosol generator shown inverted from an assembled orientation and in a spaced relationship with other components;

FIG. 7 is a schematic cross-sectional view of another aerosol generator such as the aerosol generator shown in FIG. 3;

FIG. 8 is a schematic plan view of a heating element of the aerosol generator of FIG. 3;

FIG. 9 is a schematic plan view of a resistive heating layer of the aerosol generator of FIG. 3 with a plurality of heating elements;

FIG. 10 is a flow chart showing a method of forming an aerosol generator, such as the aerosol generator of FIG. 3;

FIG. 11 is an exploded perspective view of an aerosol generator being formed;

FIG. 12 is a schematic perspective view of a resistive heating layer of an aerosol generator being formed;

FIG. 13 is a flow chart showing a method of forming an aerosol generator, such as the aerosol generator of FIG. 3;

FIG. 14 is a flow chart showing a method of forming an aerosol generator, such as the aerosol generator of FIG. 3;

FIG. 15 is a flow chart showing a method of forming an aerosol generator, such as the aerosol generator of FIG. 3;

FIG. 16 is a schematic perspective view of a resistive heating layer of an aerosol generator being formed;

FIG. 17 is a schematic plan view of a heating element of an aerosol generator;

FIG. 18A is a schematic plan view of a heating element of an aerosol generator;

FIG. 18B is a schematic plan view of another heating element of an aerosol generator;

FIG. 18C is a schematic plan view of another heating element of an aerosol generator;

FIG. 18D is a schematic plan view of another heating element of an aerosol generator;

FIG. 18E is a schematic plan view of another heating element of an aerosol generator;

FIG. 18F is a schematic perspective view of a heating element of an aerosol generator;

FIG. 19 is a schematic perspective view of a resistive heating layer having longitudinal resistive heating elements;

FIG. 20 is a schematic perspective view another resistive heating layer having longitudinal resistive heating elements; and

FIG. 21 is a flowchart of a method of manufacturing the aerosol generator.

### DETAILED DESCRIPTION

As used herein, the term “delivery mechanism” is intended to encompass systems that deliver a substance to a user, and includes: non-combustible aerosol provision systems that release compounds from an aerosolisable material without combusting the aerosolisable material, such as electronic cigarettes, tobacco heating products, and hybrid systems to generate aerosol using a combination of aerosolisable materials; and articles comprising aerosolisable material and configured to be used in one of these non-combustible aerosol provision systems.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” (which is sometimes referred to herein as an aerosolisable material) is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

In some embodiments, the substance to be delivered comprises an active substance (sometimes referred to herein as an active compound).

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

The slurry may be heated to remove at least about 60 wt %, 70 wt %, 80 wt %, 85 wt % or 90 wt % of the solvent.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise a material heatable by electrical conduction.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

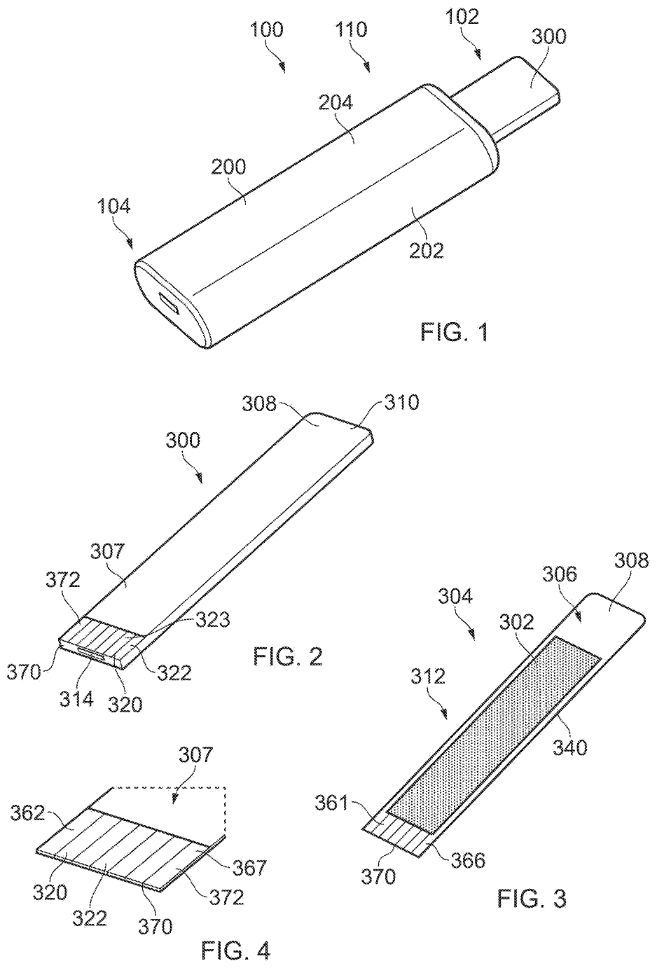

FIG. 1 shows a schematic view of an aerosol provision system 100. The aerosol provision system 100 comprises an aerosol provision device 200 and an article 300 comprising aerosol generating material 302 (refer to FIG. 3). The article 300 is shown in FIG. 2 removed from the aerosol provision device 200. An aerosol generator 304 of the article 300 is shown in FIG. 3 with a perspective view of a first side 306, with a perspective view of part of a second side 307 shown in FIG. 4.

The article 300 comprises the aerosol generator 304. The aerosol generator 304 is configured to generate an aerosol from the aerosol generating material 302 upon operation of the aerosol provision system 100, as will be describe in detail below.

The aerosol provision system 100 may be elongate, extending along a longitudinal axis. The aerosol provision system 100 has a proximal end 102, which will be closest to the user (e.g. the user's mouth) when in use by the user to inhale the aerosol generated by the aerosol provision system 100, and a distal end 104 which will be furthest from the user when in use.

The proximal end may also be referred to as the “mouth end”. The aerosol provision system 100 accordingly defines a proximal direction, which is directed towards the user when in use. Further, the aerosol provision system 100 likewise defines a distal direction, which is directed away from the user when in use. The terms ‘proximal’ and ‘distal’ as applied to features of the system 100 will be described by reference to the relative positioning of such features with respect to each other in a proximal-distal direction along a longitudinal axis.

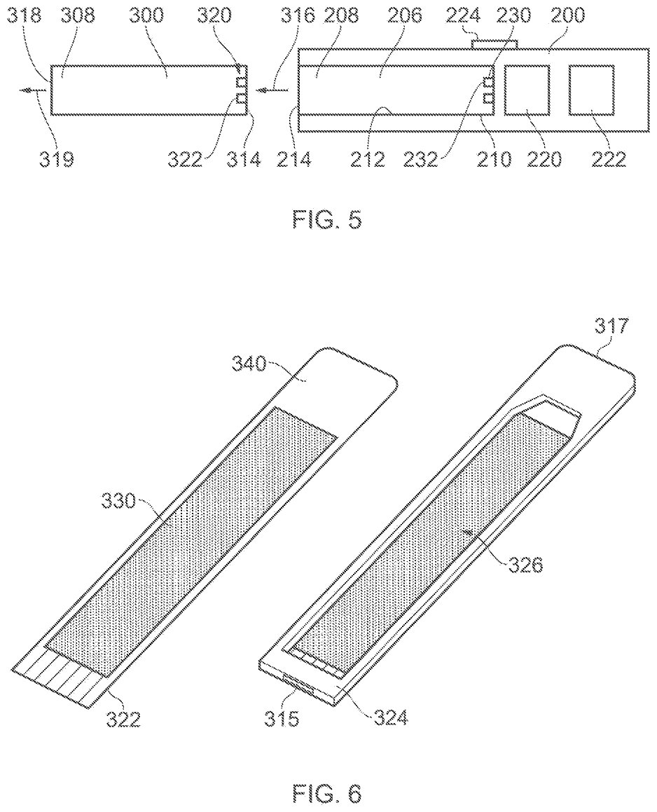

The article 300 is received by the aerosol provision device 200. The configuration of the article 300 and the aerosol provision device 200 may vary. In the present embodiment, the aerosol provision device 200 comprises a device body 202. The device has a housing 204 enclosing components of the device 200. An article receiving portion 206, sometimes referred to as a device chamber, as shown in FIG. 5, is configured to receive a portion of the article 300. A proximal end 308 of the article protrudes from the device 200 when the article 300 is received in the device chamber 206. A receptacle 208 defines the chamber 206. The receptacle 208 comprises a receptacle base 210 and a receptacle peripheral wall 212. The configuration of the receptacle 208 may vary in dependence on the configuration of the article 300.

One or more user-operable control elements 224, such as a button or switch, which can be used to operate the aerosol provision system 100 may be provided on the aerosol provision device 200. For example, a user may activate the system 100 by pressing the control element 224.

The aerosol provision device 200 comprises an opening 214 at the proximal end, leading into the device chamber 206. The opening 214 is provided in one end, through which the article 300 can be inserted. In embodiments, the article 300 may be fully or partially inserted into the device 200. The configuration of the device 200 may vary, for example the opening may be in a longitudinal side wall of the device 200, and/or may be closed by another feature of the device 200 during use. In the present configuration, the article 300 defines a mouthpiece 310 at the proximal end 308. In other embodiments, the device 200 defines the mouthpiece. The user places their mouth over the mouthpiece during use.

The device 200 defines the longitudinal axis along which an article 300 may extend when inserted into the device 200. The opening 214 is aligned on the longitudinal axis. The longitudinal axis may be an axis along which the article 300 is inserted into the device 200. The longitudinal axis may be considered to be a receiving axis of the device 200. The article 300 may similarly have a longitudinal axis along which it is inserted into the device and this axis may be considered to be an insertion axis.

The aerosol provision device 200 comprises a power source 220. The power source 220 may be a battery, for example a rechargeable battery. The device 200 also comprises a control circuit 222, acting as a controller, comprising a processor and a memory.

As discussed in detail below, a heating system 110 is configured to heat the aerosol generating material 302 of an article 300. The article 300 in embodiments is a consumable, and is interchangeable with other articles 300. The heating system 110 comprises the aerosol generator 304. The heating system 110 comprises other components of the aerosol provision system 100 including components of the article 300 and the aerosol provision device 200, for example the power source 220 and the control circuit 222.

The aerosol generator 304 forms part of the article 300. The aerosol generator 304 comprises a heating arrangement 312 configured to heat aerosol generating material 302, for example at least one of a film and a gel to generate an aerosol. The aerosol generating material may be referred to as aerosolisable material.

The heating arrangement 312 is a resistive heating arrangement. The or each heating element in embodiments is a resistive heating element, as described in detail below. In such arrangements the heating system 110 comprises a resistive heating generator including components to heat the heating arrangement 312 via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement 312 comprises electrical contacts for supplying electrical current to the resistive material. The provision of a resistive heating arrangement 312 allows for a compact arrangement.

Resistive heating provides an efficient configuration.

In the use of the aerosol provision system 100, air is drawn into an air inlet 314 of the article 300, as indicated by arrow 316. The air inlet 314 is in a distal end of the article 300. In embodiments, the air inlet 314 may have a different configuration, for example in the side. The air flow to the air inlet 314 of the article 300 may be defined, for example by at least one of an air path through the device 200, an air path external to the device 200, and an air path between the device 200 and the article 300. An aerosol generated by the aerosol generator 304 exits the device at an aerosol outlet 318, as indicated by arrow 319. In embodiments the aerosol outlet 318 is in the mouthpiece of the article 300, such that the aerosol is drawn directly from the article 300 into the mouth of a user of the device 10.

In some example embodiments, the aerosol provision system comprises two main components, namely a control section forming a reusable part and a consumable section forming a replaceable or disposable part which may be referred to as a replaceable or disposable article or cartridge. As described herein, the aerosol provision device 200 forms a control section and the article 300 forms the consumable section. In the use of the aerosol generating system, the control section and the consumable part may be releasably connected at an interface. The consumable part may be removable and replaceable, for example when the consumable part is used, with the control section being re-used with a different consumable part.

The aerosol provision system 100 as shown is provided by way of example only and is highly schematic. Different aerosol generating devices and other devices may be used in example implementations of the principles described here. For example, in some example embodiments, air is drawn into an air inlet in the control section, passes through the interface, and exits the consumable part.

As shown schematically in FIG. 5, and described in detail below, the article 300 has an article electrical contact configuration 320. The electrical contact configuration 320 in embodiments is formed by the aerosol generator 304. The electrical contact configuration 320 comprises heater electrical contacts 322. The heater electrical contacts 322 may also be known as heater or article contacts. The aerosol provision device 200 comprises an electrical connector 230. The electrical connector 230 comprises connector electrical contacts 232. The connector electrical contacts 232 may also be known as connector or device contacts. The article electrical contact configuration 320 is configured to electrically communicate with the device electrical connector 230.

The configuration of the article 300 may vary. The article 300 comprises a body 324. The body 324 is hollow. The body 324 defines a flow path 326 (refer to FIG. 6) through the article 300. The flow path 326 extends between the air inlet 314 and the aerosol outlet 318. The flow path 326 is defined by an internal space in the article along which air and/or aerosol can flow. The flow path 326 is defined in the body 324. The or each aerosol generator 304 bounds the flow path 326. The aerosol generating material 302 is exposed to the flow path 326. The aerosol generating material 302 is exposed in the internal space. The internal space in embodiments comprises two or more chambers.

The air inlet 314 comprises an opening 315. The opening 315 is formed in the body 324. In embodiments, the opening is formed in another component of the article 300, for example the aerosol generator 304 or another wall feature. The aerosol outlet 318 comprises an outlet opening 317. The outlet opening 317 is formed in the body 324. In embodiments, the outlet opening 317 is formed in another component of the article 300, for example the aerosol generator 304 or another wall feature.

As shown in FIG. 6, the article 300 comprises two aerosol generators 304 forming an aerosol generator arrangement. The number of aerosol generators 304 may differ. Each aerosol generator 304 comprises aerosol generating material 302. The aerosol generating material 302 is exposed to the flow path 326. In embodiments the article 300 comprises a single aerosol generator 304. One of the aerosol generators 304 will be described in detail, with such detail being applicable to one or more further aerosol generators 304 in embodiments.

The or each aerosol generator 304 and the body 324 are formed in a stacked configuration. In embodiments, other arrangements such as a tubular arrangement of the article are envisaged. In such tubular arrangements the aerosol generator 304 defines a tubular configuration. Tubular may include circular cross-sectional, an elliptical cross section and other polygonal shapes.

In embodiments, as shown in the Figures, the article 300 has a flat configuration. That is, wherein an exterior of the article has a length, a width perpendicular to the length, and a depth perpendicular to each of the length and the width, wherein the length is greater than or equal to the width, and wherein the width is greater than the depth. Other configurations are envisaged.

FIG. 6 is a partially exploded perspective view of the article 300, with an aerosol generator 304 shown inverted from an assembled orientation and in a spaced relationship with other components. The article 300 comprises a first one of the aerosol generator 302, the body 324 and a second one of the aerosol generator. The body 324 spaces the first and second aerosol generators 304. The first and second aerosol generators 304 close the internal space defined by the body 324 along which air and/or aerosol can flow. The aerosol generating material 302 of the first and second aerosol generators 304 face each other and is exposed to the internal space. When assembled, the first and second aerosol generators 304 sandwich the body 324. In the embodiment of FIG. 6 at least, the first and second aerosol generators 304 and the body have equal plan areas. In embodiments, one or more of the first and second aerosol generators 304 and the body 324 has a greater length and/or width. In embodiments, one of the first and second aerosol generators 304 is replaced by a blank panel. The body 324 comprises a body layer. The body may comprise a plurality of body layers. The body layers may be formed in a stack and arranged to define features of the article 300, such as the air inlet 314 and aerosol outlet 318.

A wrap encircles the article 300 and forms part of the article 300. The wrap may comprise a sheet. The wrap acts as a fixed sleeve. The or each aerosol generator 304 protrudes from the wrap at a distal end. Exposed electrical contact regions 323 of the heater contacts 322 are exposed at the distal end. Other configurations are envisaged, for example at least one exposed electrical contact region 323 may additionally or alternatively be defined along a minor longitudinal face or edge of the article 300, and on a major face of the article defined by the aerosol generator 304.

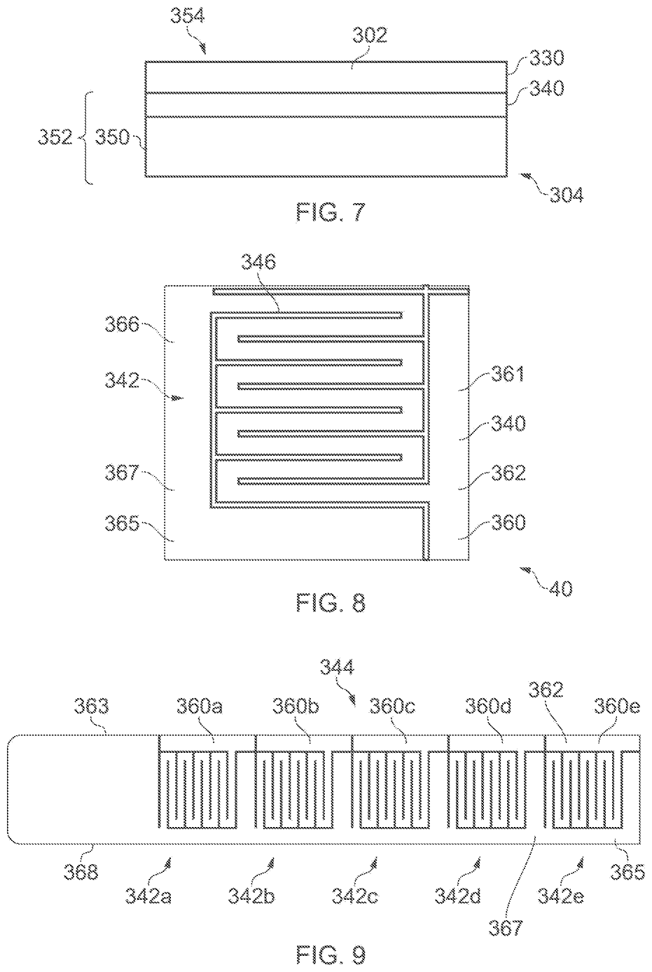

The aerosol generator 304 is schematically shown in cross section in FIG. 7. The aerosol generator 304 is an implementation of the aerosol generator 304 of the aerosol provision system 100 described above.

The aerosol generator 304 comprises an aerosol generating layer 330. The aerosol generating layer is also known as an aerosolisable layer. The aerosol generating layer 330 comprises the aerosol generating material 302. The aerosol generator 304 comprises a resistive heating layer 340. The resistive heating layer 340, in embodiments, is formed as an electrically conductive layer. The aerosol generating layer 330 is on the resistive heating layer 340. The aerosol generating layer 330 is in direct contact with the resistive heating layer 340. In embodiments, the aerosol generating layer 330 is in indirect contact with the resistive heating layer 340. The resistive heating layer 340 may in embodiments comprise a coating. As described in detail below, the resistive heating layer 340 comprises a plurality of resistive heating elements 342, for example as shown in FIGS. 8 and 9. The or each resistive heating element 342 forms at least a portion of an electrically conductive path between a pair of the electrical contacts 322. The or each resistive heating element 342 provides the electrically conductive path for resistive heating of at least of portion of the aerosol generating material 302 to generate an aerosol. The aerosol generating material 302 is, in embodiments, in the form of a film or a gel.

The resistive heating layer 340 is formed as an electrically conductive layer. This layer in embodiments takes the form of at least one of a metal layer, such as an aluminium layer, or a non-metallic material, such as graphene. The resistive heating layer 340 is in the form of a foil, for example an aluminium foil.

The aerosol generator 304 comprises a support 350. The support 350 in embodiments comprise a paper or card material. The support 350 provides structural support for the aerosol generator 304. The resistive heating layer 340 is on the support 350. The support 350 is configured as a support layer. As shown in FIG. 7, in the aerosol generator 304, the resistive heating layer 340 is sandwiched between the support 350 and the aerosol generating layer 330.

The support 350 is electrically insulative. The resistive heating layer 340 and the support layer 350 define a substrate 352. The substrate 352 supports the aerosol generating layer 330.

The article 300 may comprise a laminate 354 comprising the resistive heating layer 340 and the support layer 350. In embodiments, the laminate 354 comprises the aerosol generating layer 330. The aerosol generating layer 330 may be formed as a contiguous configuration, or may be formed from discrete portions. The discrete portions may comprise one or more of dots, strips, spirals, or other shapes.

One or more of the aerosol generating layer 330, resistive heating layer 340 and the support layer 350 may comprise a further layer. For example the support layer 350 may comprise a backing layer or an intermediate layer. The support layer 350 in embodiments is omitted.

FIG. 8 shows one of the resistive heating elements 342. The resistive heating layer 340 comprises a plurality of resistive heating elements 342. In embodiments, the resistive heating layer 340 comprises a single resistive heating element 342.

The plurality of heating elements 342 may be formed in an array 344 as shown in FIG. 9. Other configurations are envisaged.

The resistive heating element 342 comprises a resistive heating path. The resistive heating path is formed by an electrically conducting path. The resistive heating path is non-straight. The resistive heating path is convoluted. The configuration of the resistive heating path may vary. The electrical resistance of the heating element 342 may be dependent on the nature of the resistive heating path in the conductive layer, for example the length, width, thickness and arrangement of the path.

The resistive heating element 342 extends between a first type of electrical contact 360 and a second type of electrical contact 365. The first type of electrical contact 360 is configured to provide a positive contact and the second type of electrical contact 365 is configured to provide a negative contact. Electrical current flows between the first type of electrical contact 360 and the second type of electrical contact 365 through the path. The contact arrangement may be reversed. The first and second types of electrical contacts 360, 365 are heater electrical contacts 322. The first and second types of electrical contacts 360, 365 form at least part of the article electrical contact configuration 320.

The meandering or serpentine nature of the path of the resistive heating element 342 is such that the electrical resistance of the path is increased when compared with a straight path between the first and second type of electrical contacts.

The resistive heating layer 340 may comprise a first type of electrical track 361 extending from the resistive heating element 342. The first type of electrical track 361 comprises the first type of electrical contact 360. The electrical contact 360 of the first type is configured to electrically connect with the device electrical connector 230. The first type of electrical contact 360 comprises a first type of exposed contact region 362. The first type of exposed contact region 362 is exposed on the article for direct connection with the device electrical connector 230.

The resistive heating layer 340 may comprise a second type of electrical track 366 extending from the resistive heating element 342. The second type of electrical track 366 comprises the second type of electrical contact 365. The electrical contact 365 of the second type is configured to electrically connect with the device electrical connector 230. The second type of electrical contact 365 comprises a second type of exposed contact region 367. The second type of exposed contact region 367 is exposed on the article 300 for direct connection with the device electrical connector 230.

As discussed in detail below, the conducting path of the resistive heating element 342 in embodiments is created by defining at least one electrically conductive barrier 346 in the resistive heating layer 340. In embodiments, the electrically conductive barrier 346 is formed by cutting electrically conductive barrier restrictions (i.e. electrically insulating portions), such as gaps, channels or slots into a sheet formed of electrically conductive material to form the resistive heating layer 340. In embodiments, the electrically conductive element 342 is preformed to define the or each resistive heating element 342 and then applied to the support 350. In embodiments, the resistive heating layer 340 is applied to the support 350, and the or each resistive heating element 342 then defined in the resistive heating layer 340. The or each restive heating element 342 defining the resistive heating layer 340 may be a printed heater.

The at least one electrically conductive barrier 346 defines the first and second types of electrical track 361, 366.

In some embodiments, the tracks of the or each resistive heating element 342 have a width in the region of 0.5 mm to 1 mm (two example prototypes have widths of 0.93 mm and 0.72 mm respectively) and gaps between the tracks of less than about 0.25 mm (the same two example prototypes have gaps of 0.2 mm and 0.05 mm respectively). The or each resistive heating element 342 may have overall dimensions of the order of 10 mm×10 mm. Other dimensions are possible in other example embodiments. By forming the or each resistive heating element 342 of these dimensions from an aluminium foil of having a thickness of 0.006 mm and an electrical resistivity of between 2 and 6 μOhmcm, the resistance of the path has been calculated to be of the order of 1 Ohm. In one example embodiment, the resistance was measured at between 0.83 and 1.31 Ohms.

As shown in FIG. 9, the resistive heating layer 340 may be formed into a plurality of resistive heating elements, indicated generally by the reference numerals 342a, 342b, 242c, 342d and 342e. Each of the resistive heating elements 342a-342e extends from a respective one of the first type of electrical contact, indicated generally by the reference numerals 360a, 360b, 360c, 360d and 360e to a single second type of electrical contact 365. The number of electrical contacts may vary. As such, each resistive heating element 342a-342e extends between a discrete first type of electrical contact and a common second type of electrical contact.

Each of the resistive heating element 342a-342e provides an electrically conductive path for resistive heating of a portion of the aerosol generating material 302 to generate an aerosol at the respective portion of the aerosol generator 304.

The separate first type 360a-360e of electrical contacts enable an electric current to be individually provided to each of the plurality of resistive heating elements 342a-342e. The heating of different zones of the aerosol generating layer 330 can be controlled. For example, an aerosol generator may be provided with five aerosol generating zones. The resistive heating layer 340 allows each of those zones to be activated separately. Accordingly, for example, five puffs of aerosol may be generated from a single consumable incorporating a single aerosol generator 304, and ten puffs of aerosol may be generated from a single consumable incorporating two aerosol generators 304.

In the example resistive heating layer 340, the plurality of first type of electrical contacts 360a-360e, for example a positive electrical connection, are provided and a single second type of electrical contact 365, for example a negative electrical connection is provided. This is not essential to all implementations. For example, multiple contacts of the second type could be provided. In embodiments each resistive heating element 342a-342e comprises a corresponding one of the first type of electrical contact 360 and a corresponding one of the second type of electrical contact 365.

In the shown embodiment of FIG. 9 of the resistive heating layer 340, the first type of electrical contacts 360a-360e are arranged on a first edge 363 of the resistive heating layer 340 and the second type of electrical contact 365 is arranged on a second edge 368 of the resistive heating layer 340. This may allow for convenient connection of electrical power, but, of course, many other configurations are possible, some of which are discussed further below.

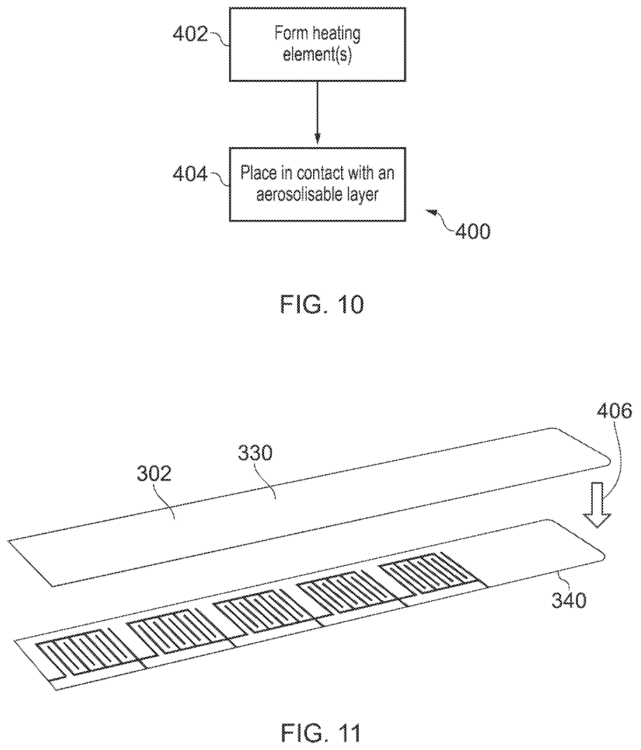

FIG. 10 is a flow chart showing part of a method of forming an aerosol generator 304 or an algorithm, indicated generally by the reference numeral 400, in accordance with an example embodiment.

The method or algorithm 400 starts at operation 402, where a resistive heating layer is formed into one or more heating elements (e.g. a plurality of heating elements), wherein each resistive heating element extends from an electrical contact of a first type to an electrical contact of a second type. In use, the or each heating element may be used to provide an electrically conductive path for resistive heating of a portion of an aerosol generating material to generate an aerosol. The formation of the or each resistive heating element may occur prior to or post application of the resistive heating layer on a support, where a support is present. The resistive heating layer may be adhered to the support, or mounted or formed on the support in a different configuration.

At operation 404, the formed the resistive heating layer is placed in contact with the aerosol generating layer, wherein said aerosol generating layer incorporates aerosol generating material. Algorithm 400 may be used to produce the aerosol generator 304 described above.

FIG. 11 shows the aerosol generator 304 being formed in accordance with an embodiment. The aerosol generating material 302 is formed on the resistive heating layer 340 by depositing aerosol generating material, for example by spraying, painting, dispensing or in some other way. The aerosol generating layer 330 is disposed on resistive heating layer 340 as indicated by the arrow 406, in an example implementation of the operation 64.

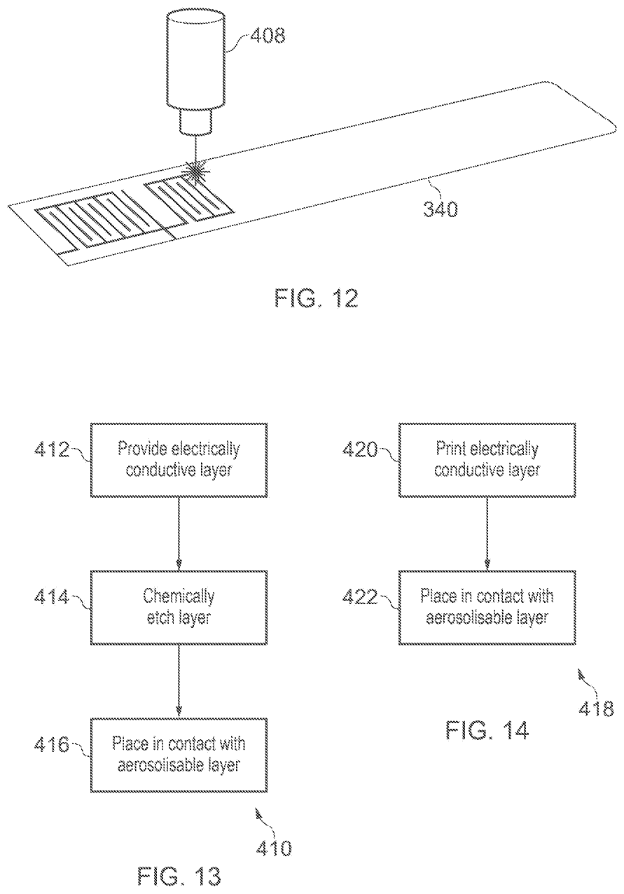

FIG. 12 shows the resistive heating layer 340 being formed in accordance with an example embodiment. The resistive heating layer 340 is in the process of being cut using a laser cutter 408. The cutting of the resistive heating layer 340 can be used to form the paths of the heating elements described herein. The use of the laser cutter 408 (or some other cutting process) is not the only method by which the resistive heating layer 340 described herein may be generated. Some example methods are described below.

FIG. 13 is a flow chart showing part of a method of forming an aerosol generator 304 or an algorithm, indicated generally by the reference numeral 410. The method or algorithm 410 starts at operation 412, where the resistive heating layer is provided. At operation 414, one or more of the resistive heating elements are formed in the resistive heating layer by chemically etching the resistive heating layer. The operations 412 and 414 are an example implementation of the operation 402 of the method 400 described above. The aerosol generating material is then disposed on the resistive heating layer, thereby implementing the operation 404 described above.

FIG. 14 is a flow chart showing part of a method of forming an aerosol generator 304 or an algorithm, indicated generally by the reference numeral 418. The method or algorithm 418 starts at operation 420, where one or more heating elements are formed, at least in part, by printing a resistive heating layer. The operation 420 is therefore an example implementation of the operation 62 of the algorithm 402 described above. The aerosol generating material is then disposed on the resistive heating layer, thereby implementing the operation 404 described above.

The cutting, etching and printing methods described above are provided by way of example; other additional or alternative methods are also possible. For example, a so-called “hot foiling” approach could be used in which a heating element is made out of a resistive heating layer, and then assembled/bonded onto a support. Yet other techniques could be used, such as die cutting. Moreover, two or more technologies could be combined (e.g. electrical conductivity could be added to connection traces by adding more conductive material, such as additional foil, printed material, etc.). The skilled person will be aware of many further technologies, or combinations of technologies, that could be used in implementations of the principles described herein.

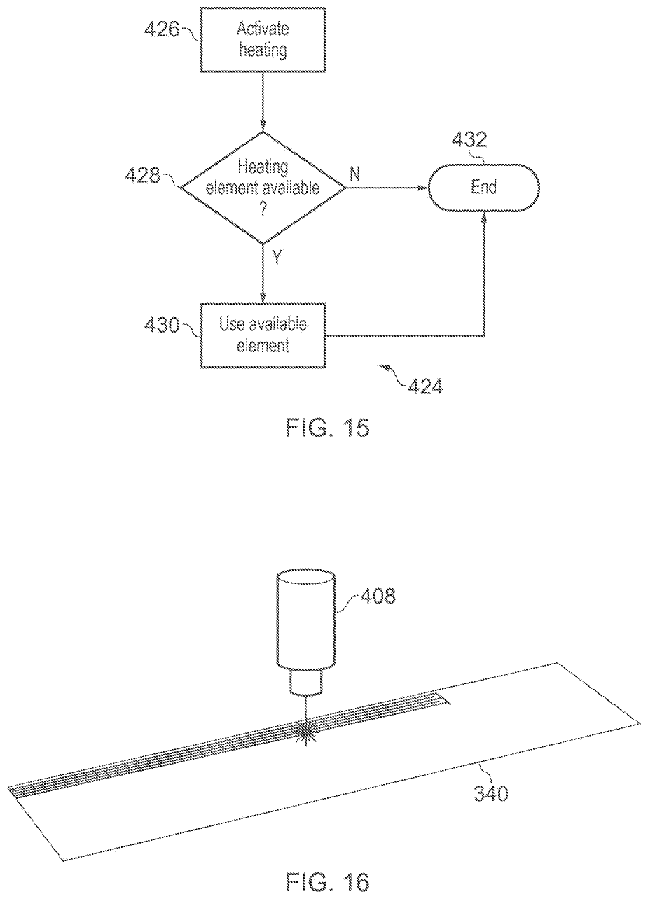

FIG. 15 is a flow chart showing method of operation or an algorithm, indicated generally by the reference numeral 424, in accordance with an example embodiment. The method or algorithm 424 may, for example, be implemented using any of the aerosol generators described herein. The method or algorithm 424 is initiated when an instruction to activate heating is received in an instance of operation 426. In response to the instruction to activate heating, a determination is made (in operation 428) regarding whether a heating element is available. As discussed above, a plurality of heating elements may be provided. The operation 428 may involve determination which of the heating elements have been used and/or the corresponding available aerosol generating material used up.

If a heating element is available, the algorithm moves to operation 430, where an available heating element is used. As discussed above, heating elements may be individually controllable, for example by providing electrical power to individual heating elements. Once the operation 430 is complete, the algorithm terminates at operation 432. If, at operation 428, a determination is made that no heating elements are available, for example because all heating elements have been used, then the algorithm terminates at operation 432. This may mean that a consumable part being used to implement the algorithm 424 needs to be replaced.

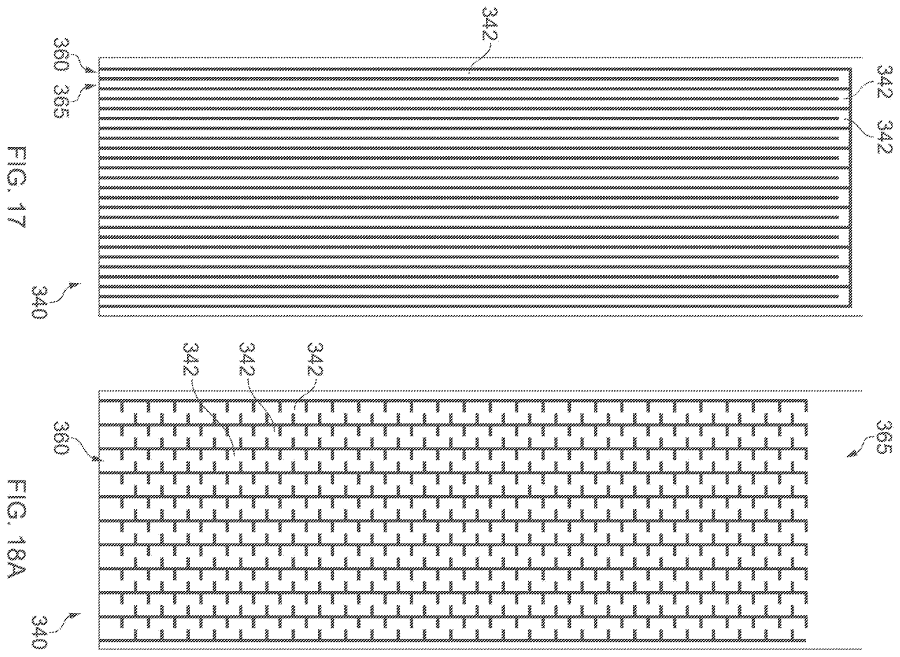

FIG. 16 shows the resistive heating layer 340 being formed in accordance with an embodiment. The resistive heating layer 340 is being cut using the laser cutter 408, although other methods could be used, such as chemical etching or printing, as discussed above. The cutting of the electrically conductive layer 340 forms the heating elements as described herein.

In the embodiment of FIG. 16, the paths cut are linear paths, extending along the length of the electrically conductive layer 120.

FIG. 17 shows another embodiment of the resistive heating layer 340. The resistive heating layer 340 may be formed using the laser cutter 408 described above, or some similar device or another method. The resistive heating layer 340 comprises a plurality of resistive heating elements 342, each resistive heating element 342 being a linear heating element comprising a conducting path extending along a length of the resistive heating layer 340. Each resistive heating element 342 extends from one of the first type of electrical contact 360, for example a positive electrical connection to one of the second type of electrical contact 365, for example a negative electrical contact. In such an embodiment, both types of electrical contact are provided at the same end of the resistive heating layer 340 and are provided next to each other. In this embodiment, the first and second type of electrical contacts are interspersed or interlocked or interlaced with each other. In other words, each of the first type of electrical contacts is arranged to be between one or two adjacent second type of electrical contacts and each of the second type of electrical contacts is arranged to be between one or two adjacent second type of electrical contacts. In such an arrangement there is no common second type of electrical contact as is some other embodiments; instead, each heating element has separate first and second types of electrical contacts. In other embodiments, there may be a common second type of electrical contact. In such embodiments, the common second type of electrical contact may be provided on an edge of the aerosol provision that is different from the edge of the aerosol generator that has the first type of electrical contact.

In some embodiments, one or more resistive heating elements 342 can be considered to be extending back and forth along a majority of the aerosol generator in the longitudinal direction the longitudinal direction. The term “majority” may be considered to mean more than 50%. For example, one or more of the resistive heating elements 342 may be considered to be extending forth from a first type of electrical contact on a first edge of the resistive heating layer to a point proximate to a second edge opposing the first edge. In the present context, the term “proximate to the second edge” may be considered to mean closer to the second edge than the first edge. The resistive heating element at the point bends or turns around. For example, bending around may mean rotating or turning by an angle of approximately 180°. After the point the resistive heating element extends back from the bend/turn and/or the point towards to the second type of electrical contact. The second type of electrical contact is positioned on the same edge as the first type of electrical contact.

In this embodiment, the resistive heating layer 340 (and the aerosol generator comprising the resistive heating layer) is elongate along a longitudinal direction. In this embodiment, each of the resistive heating elements is spaced apart or displaced from its adjacent resistive heating elements in a lateral direction perpendicular to the longitudinal direction.

Advantageously, the above-described longitudinal heating element arrangement allows for the manufacture of the resistive heating layer and/or the resulting aerosol generator to be easier and/or faster. This is because the formation of the resistive heating elements can be performed predominately along the longitudinal direction which tends to be the direction that the resistive heating layer predominately moves during manufacture. As such, the forming of the resistive heating elements can be at least partially done at the same time as the moving of the resistive heating layer, e.g. from one station to another. moving of the resistive heating element and/or formation devices tends to be reduced thereby decreasing the time and complexity of the manufacture processes.

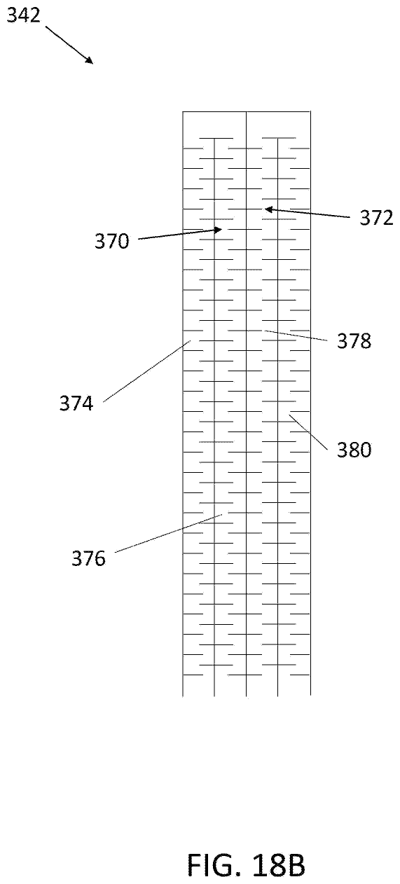

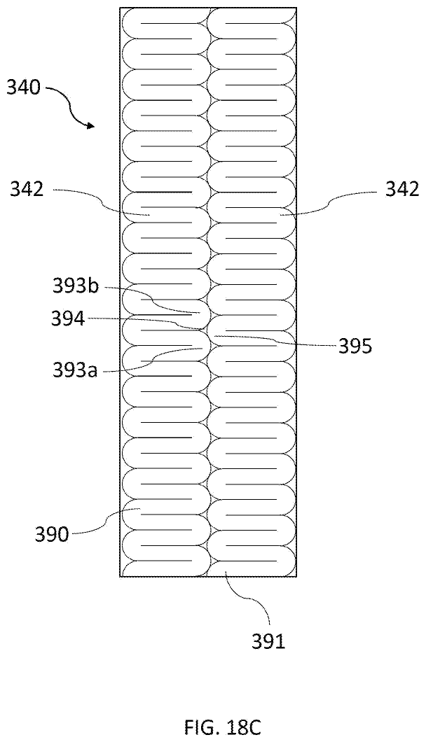

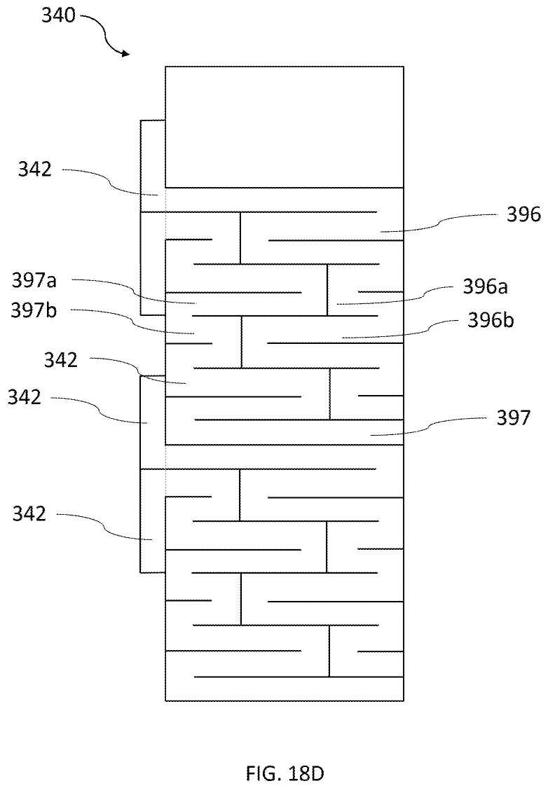

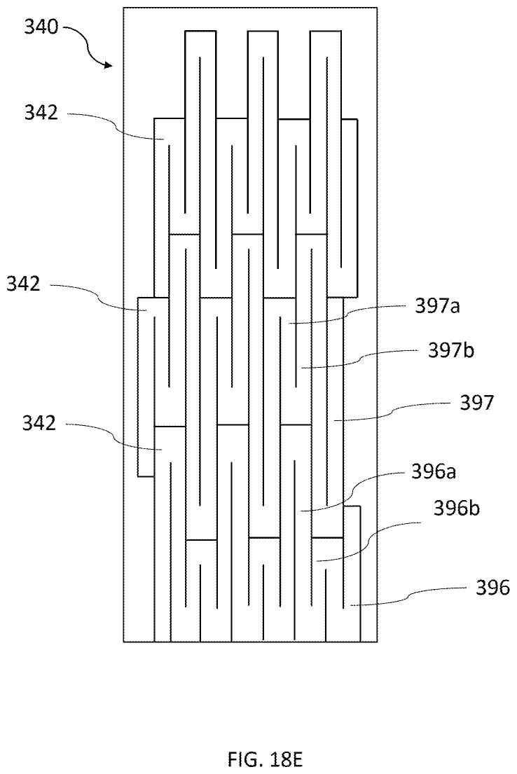

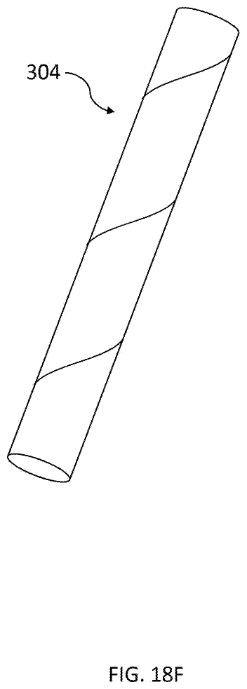

FIG. 18A shows another embodiment of the resistive heating layer 340. The resistive heating layer 340 may be formed using the laser cutter 408 described above, or some similar device or another method. The resistive heating layer 340 comprises a plurality of heating elements 342, each heater element 342 being a linear heating element comprising a conducting path extending along a length of the resistive heating layer 340. Each resistive heating element 342 extends from one of the first type of electrical contact 360, for example a positive electrical connection to the second type of electrical contact 365, for example a negative electrical contact. In such an embodiment, the different types of electrical connection are provided at the opposite ends of the resistive heating layer 340 and a common second type of electrical contact is provided. In some embodiments, the different types of electrical connection are provided at the same end of the resistive heating layer 340 and a common second type of electrical contact is provided. Although a linear path is provided, an increase in the electrical resistance may be provided by means of providing a crenelated path, acting as a convoluted path. In other words, the resistive heating element may be considered to have a shape or a path that is serpentine. Note that the paths of any other embodiments described herein could also be crenelated.

In some embodiments, the turns (i.e. turns towards a lateral direction, with the lateral direction normal to the longitudinal direction) in the serpentine path of a resistive heating element 342 are in an opposite direction to the turns (also turns towards the lateral direction) in the serpentine path of an adjacent resistive heating element 342. In an example, there is a first resistive heating element and a second adjacent resistive heating element. The first and second resistive heating elements both extend longitudinally in one direction only. The first and second resistive heating element both have serpentine paths. The turns in the first resistive heating element are opposite to the turns in the second resistive heating element. Specifically, when the first resistive heating element turns away from second resistive heating element, the second resistive heating element (adjacent to the first resistive heating element) also turns away from the first resistive heating element. Similarly, when the first resistive heating element turns towards the second resistive heating element, the second resistive heating element also turns towards from the first resistive heating element.

In FIG. 18B, the resistive heating layer comprises a first resistive heating element 370 and a second adjacent resistive heating element 372. The first and second resistive heating elements 370, 372 both extend back and forth along the longitudinal direction. The first resistive heating element 370 comprises a first leg 374 that extends forth from a first end to a second end and a second leg 376 (adjacent to the first leg 374) that extends back from the second end to a first end. The second resistive heating element 372 comprises a first leg 378 that extends forth from the first end to the second end and a second leg 380 (adjacent to the first leg 378) that extends back from the second end to the first end.

Each of the first and second legs have serpentine paths. The turns in the serpentine path of the first leg 374 of the first resistive heating element 370 are opposite to the turns in the serpentine path of the second leg 376 of the first resistive heating element 370. Specifically, when the first leg 374 turns away from second leg 376, the second leg 376 also turns away from the first leg 374. Similarly, when the first leg 374 turns towards the second leg 376, the second leg 376 also turns towards from the first leg 374.

The turns in the serpentine path of the first leg 378 of the second resistive heating element 372 is opposite to the turns in the serpentine path of the second leg 380 of the second resistive heating element 372. Specifically, when the first leg 378 turns away from second leg 380, the second leg 380 also turns away from the first leg 378. Similarly, when the first leg 378 turns towards the second leg 380, the second leg 380 also turns towards from the first leg 378.

The turns in the first leg 374 of the first resistive heating element 370 are in the same direction as the turns in the first leg 378 of the second resistive heating element 372. The turns in the second leg 376 of the first resistive heating element 372 are in the same direction as the turns in the second leg 380 of the second resistive heating element 372.

Advantageously, this configuration of the resistive heating elements and/or resistive heating layer allows for the a more efficient manufacturing process. Specifically, the formation of the serpentine path can be done with e.g. lateral cuts that extend across adjacent legs and/or adjacent resistive heating elements. For example, laser cutting may be performed with a single cut that cuts across two legs or two resistive heating elements. In other words, that single cut forms two turns, each of which turns a respective leg away from each other. This allows for a more efficient formation process as one lateral movement may form part of the serpentine path for at least two adjacent legs.

FIG. 18C shows another embodiment of the resistive heating layer 340. In FIG. 18C, the resistive heating layer comprises a first resistive heating element 390 and a second adjacent resistive heating element 391. The first and second resistive heating elements 390, 391 both extend along the longitudinal direction. The first and second resistive heating elements 390, 391 each have serpentine paths with turns. The turns in the first and second resistive heating elements 390, 391 are rounded. That is, each turn has a radius. At each turn the path turns through substantially 180 degrees.

As can be seen, recesses are formed between alternate turns in each of the first and second resistive heating elements 390, 391 due to the rounded nature of the turns. Example alternate turns in the first resistive heating element are shown by 393a and 391b. “Alternate turn” may mean the next turn in the same direction, such that every other turn may be “alternate”. Alternate turns may be adjacent to each other. An example recess 394 is shown between alternate turns 393a, 393b.

Such recesses in the first resistive heating element 390 provide space into which turns of the second resistive heating element may be partially received. As can be seen, an example turn 395 in the second resistive heating element 391 may be partially received within the recess 394.

Due to the repetitive nature of the rounded turns in each of the first and second resistive heating elements 390, 391, the first and second resistive heating elements may be nested, as shown. Turns of the first resistive heating element 390 nest in recesses of the second resistive heating element 391, and similarly, the turns of the second resistive heating element 391 nest in recesses of the first resistive heating element 390.

Advantageously, this configuration of the resistive heating elements may save overall space (e.g. reducing width required) across multiple heater zones and may maximise the heated area.

Although only a first and a second resistive heating elements are shown in FIG. 18C, it is to be understood that more than two resistive heating elements may be present. For example, a third resistive heating element may be present. The third resistive heating element may nest with the second resistive heating element, such that the second resistive heating element nests with both the first and third resistive heating elements.

FIG. 18D shows another embodiment of the resistive heating layer 340. In FIG. 18D, the resistive heating layer comprises a first resistive heating element 396 and a second resistive heating element 397 adjacent thereto. In the present embodiment, third and fourth resistive heating elements are shown. It is to be understood that only the first and second resistive heating elements 363, 367 may be present. Alternatively, more than two resistive heating elements may be present. The first and second resistive heating elements 396, 397 each have a serpentine path. The lateral path lengths of the first and second resistive heating elements 396, 397 each may differ. For example, the length of lateral path 396a is different to lateral path 396b. Similarly, lateral paths 397a, 397b differ. As can be seen, first and second resistive heating elements 396, 397 may be interlaced due to the differing path lengths. It can be seen that at certain lateral positions, the first and second resistive heating elements 396, 397 alternate in the longitudinal direction. In particular, in the present embodiment, such alternation can be seen along a central longitudinal axis.

FIG. 18E shows another embodiment of the resistive heating layer 340. This embodiment is similar to that shown in FIG. 18D, in particular, the first and second resistive heating elements 396, 397 are interlaced as in FIG. 18D. In the present embodiment, the first and second resistive heating elements alternate in the lateral direction. As above, only first and second resistive heating elements may be present. Alternatively, more than two resistive heating elements may be present.

Advantageously, these interlaced configurations may also save space (e.g. reducing width required) across multiple heater zones may maximise the heated area.

FIG. 18F shows an aerosol generator 304 of any of the above embodiments. The aerosol generator 304 is twisted or rolled so as to be tubular or straw-like. The aerosol generator is twisted so as to form a helical configuration. In the following, reference is made to first and second resistive heating elements, such as those described in any of the above embodiments. As discussed above, there may be more than two resistive heating elements. It will be understood that the resistive heating elements face inwardly. As can be understood from FIG. 18F, the first and second resistive heating elements (not shown) will inherently follow a helical path due to the twisting of the aerosol generator 304.

Advantageously, such a tubular article has the benefit that it may be more easily wrapped with a cylindrical wrapper compared to a flat, non-twisted, article. Therefore, the manufacturing process may be made more efficient.

In each of the aerosol generators shown in FIG. 18A-F, a first resistive heating element is displaced from a second resistive heating element in the lateral direction.

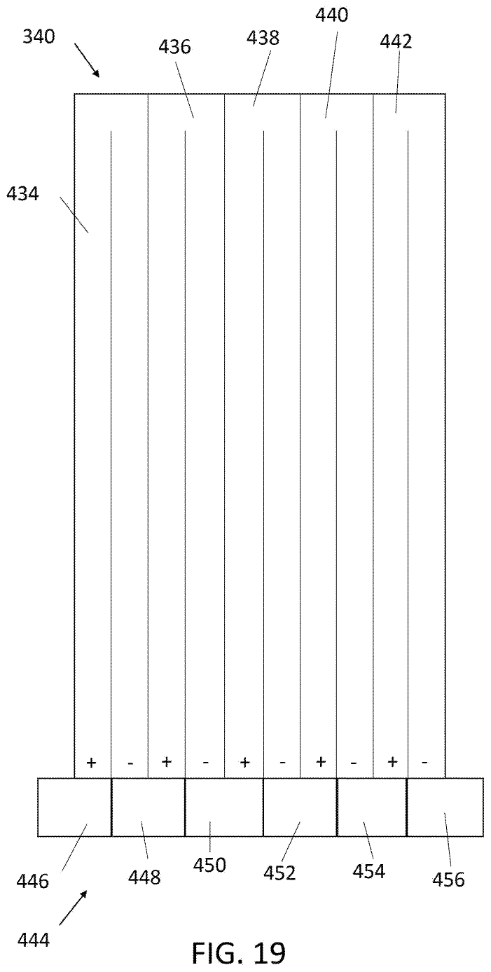

FIG. 19 shows an embodiment of the resistive heating layer 340. The resistive heating layer 340 may be the same or have the one or more of the features of any of the above described resistive heating layers. In this embodiment, the resistive heating layer 340 comprises a first resistive heating element 434, a second resistive heating element 436, a third resistive heating element 438, a fourth resistive heating element 440, and a fifth resistive heating element 442. In other embodiments, the resistive heating layer may comprise any number of a plurality of resistive heating element.

The resistive heating layer 420 further comprises a plurality of contact pads 444. Each of the contact pads 444 is configured to engage the device electrical connector 230 that is connected to a power source 220 such that power can be provided to resistive heating elements 342 to generate heat. The contact pads 444 are also electrically isolated from each other. The contact pads comprise a first end contact pad 446 positioned at a first edge of the resistive heating layer 340. The first edge extends along the longitudinal direction. In FIG. 19 the first edge is shown as the left side edge of the resistive heating layer 420. The first contact pad 446 is only in electrical connect with the first type of electrical contact (+) of the first resistive heating element 434.

The contact pads 444 further comprise one or more intermediate contact pads. Each of which is in electrical contact with a respective first type of electrical contact of one resistive heating element and a respective second type of electrical contact of an adjacent resistive heating element. In this embodiment, the one or more intermediate contact pads further comprise a second contact pad 448, a third contact pad 450, a fourth contact pad 452, and a fifth contact pad 454.

The second contact pad 448 is in electrical contact with the second type of electrical contact of the first resistive heating element 434. The second contact pad 448 is also in electrical contact with the first type of electrical contact of the second resistive heating element 436.

The third contact pad 450 is in electrical contact with the second type of electrical contact of the second resistive heating element 436. The third contact pad 450 is also in electrical contact with the first type of electrical contact of the third resistive heating element 438.

The fourth contact pad 452 is in electrical contact with the second type of electrical contact of the third resistive heating element 438. The fourth contact pad 452 is also in electrical contact with the first type of electrical contact of the fourth resistive heating element 440.

The fifth contact pad 454 is in electrical contact with the second type of electrical contact of the fourth resistive heating element 440. The fifth contact pad 454 is also in electrical contact with the first type of electrical contact of the fifth resistive heating element 442.

The contact pads further comprise a sixth end contact pad 456 positioned at a second edge of the resistive heating layer 340. The second edge extends along the longitudinal direction. The second edge is positioned opposite to the first edge. In FIG. 19 the second edge is shown as the right-side edge of the resistive heating layer 340. The sixth end contact pad 456 is only in electrical connect with the second type of electrical contact (−) of the fifth resistive heating element 442.

In this arrangement, each of the resistive heating elements can be activated individually. For example, each of the contact pads may be electrically connected to a respective connector electrical contact 232 (as described above). A controller may allow power to flow from one adjacent connector electrical contacts 232 to an adjacent connector electrical contact 232. This in turn means that power flows from one of the contact pads 444 to an adjacent contact pad 444 since there is only ever one resistive heating element between adjacent contact pads 444 only one resistive heating element is activated. In this embodiment, the polarity of the power supplied to intermediate contact pads (e.g. second 448, third 450, fourth 452, and fifth 454 contact pads) changes depending on which resistive heating element is to be activated. For example, to activate the first resistive heating element 434, positive terminal needs to be connected to first contact pad 446 and negative terminal needs to be connected to the second contact pad 448. To activate the second resistive heating element 436, now the positive terminal needs to be connected to the second contact pad 448 and the negative terminal needs to be connected to the third contact pad 450. As such, the polarity of the power supplied to the second contact pad 448 changes depending on which resistive heating element is to be activated. This similarly applies to the other intermediate contact pads 450, 452, 454. For example, the connector electrical contacts 232 can be control so that only the first and second contact pads 446, 448 are electrically connected to the power source 220. In this way, only the first resistive heating element 434 would be part of a complete electrical circuit. Therefore, only the first resistive heating element 434 would be activated to provide heating.

Similarly, the connector electrical contacts 232 can be control so that only the second and third contact pads 448, 450 are electrically connected to the power source 220. In this way, only the second resistive heating element 436 would be part of a complete electrical circuit. Therefore, only the second resistive heating element 436 would be activated to provide heating.

Similarly, the connector electrical contacts 232 can be control so that only the third and fourth contact pads 450, 452 are electrically connected to the power source 220. In this way, only the third resistive heating element 438 would be part of a complete electrical circuit. Therefore, only the third resistive heating element 438 would be activated to provide heating.

Similarly, the connector electrical contacts 232 can be control so that only the third and fourth contact pad 452, 454 are electrically connected to the power source 220. In this way, only the fourth resistive heating element 440 would be part of a complete electrical circuit. Therefore, only the fourth resistive heating element 440 would be activated to provide heating.

Similarly, the connector electrical contacts 232 can be control so that only the third and fourth contact pad 454, 456 are electrically connected to the power source 220. In this way, only the fifth resistive heating element 442 would be part of a complete electrical circuit. Therefore, only the fifth resistive heating element 442 would be activated to provide heating.

Since the resistive heating elements in the middle share contact pads, the number of contact pads tends to be reduced. Advantageously, the number of electrical contacts for supplying power tends to be reduced while maintaining control over individual activation of each of the resistive heating elements.

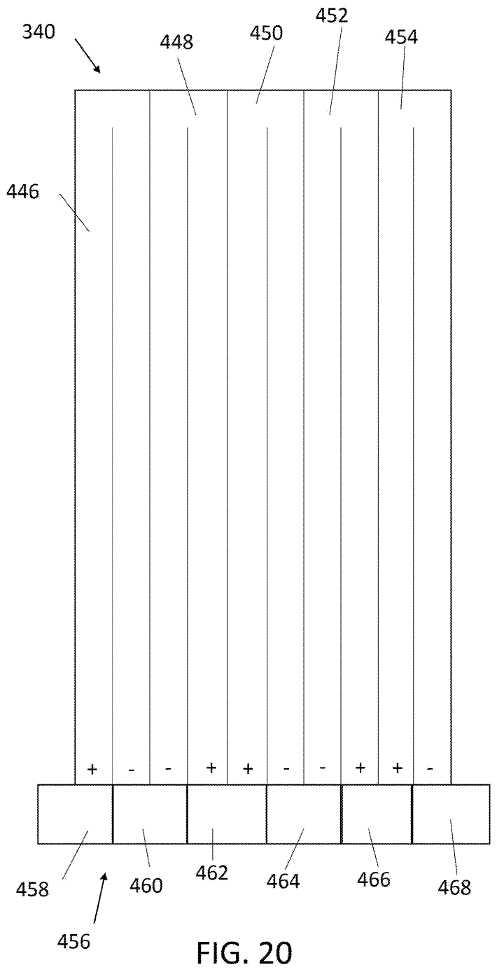

FIG. 20 shows another resistive heating layer 340. The resistive heating layer 340 may be the same or have one or more of the features of any of the above described resistive heating layers 340. In this embodiment, the resistive heating layer 340 comprises a first resistive heating element 446, a second resistive heating element 448, a third resistive heating element 450, a fourth resistive heating element 452, and a fifth resistive heating element 456. In other embodiments, the resistive heating layer may comprise any number of a plurality of resistive heating element.

The resistive heating layer 340 further comprises a plurality of contact pads 456. Each of the contact pads 456 is configured to engage the device electrical connector 230 that is connected to a power source 220 such that power can be provided to resistive heating elements 342 to generate heat. The contact pads 456 are also electrically isolated from each other. The contact pads comprise a first end contact pad 458 positioned at a first edge of the resistive heating layer 340. The first edge extends along the longitudinal direction. The first end contact pad 458 is only in electrical connect with the first type of electrical contact (+) of the first resistive heating element 340.

The contact pads further comprise one or more intermediate contact pads, each of which is in electrical connection with the same type of electrical contacts from two adjacent resistive heating elements 342. In this embodiment, the plurality of contact pads 456 further comprise a second contact pad 460, a third contact pad 462, a fourth contact pad 464, and a fifth contact pad 466.

The second contact pad 460 is in electrical contact with the second type of electrical contact of the first resistive heating element 446. The second contact pad 460 is also in electrical contact with the second type of electrical contact of the second resistive heating element 448.

The third contact pad 462 is in electrical contact with the first type of electrical contact of the second resistive heating element 448. The third contact pad 462 is also in electrical contact with the first type of electrical contact of the third resistive heating element 450.

The fourth contact pad 464 is in electrical contact with the second type of electrical contact of the third resistive heating element 450. The fourth contact pad 464 is also in electrical contact with the second type of electrical contact of the fourth resistive heating element 452.

The fifth contact pad 466 is in electrical contact with the first type of electrical contact of the fourth resistive heating element 452. The fifth contact pad 466 is also in electrical contact with the first type of electrical contact of the fifth resistive heating element 454.

The contact pads further comprise a sixth end contact pad 468 positioned at a second edge of the resistive heating layer 340. The second edge of the resistive heating layer 340 extends along the longitudinal direction of the resistive heating layer 340. The second edge is positioned opposite to the first edge. The sixth end contact pad 468 is only in electrical connect with the second type of electrical contact (−) of the fifth resistive heating element 454.

In this arrangement, each of the resistive heating elements can be activated individually. For example, each of the contact pads may be electrically connected to a respective connector electrical contact 232 (as described above). A controller may allow power to flow from one adjacent connector electrical contacts 232 to an adjacent connector electrical contact 232. This in turn means that power flows from one of the contact pads 456 to an adjacent contact pad 456 since there is only ever one resistive heating element between adjacent contact pads 456 only one resistive heating element is activated. Furthermore, each of the contact pads is only in contact with one type of electrical contact (positive or negative). As such, the need to switch polarities to individually activate different resistive heating elements tends to be avoided.

For example, the connector electrical contacts 232 can be control so that only the first and second contact pads 458, 460 are electrically connected to the power source 220. In this way, only the first resistive heating element 446 would be part of a complete electrical circuit. Therefore, only the first resistive heating element 446 would be activated to provide heating.

Similarly, the connector electrical contacts 232 can be control so that only the second and third contact pads 458, 460 are electrically connected to the power source 220. In this way, only the second resistive heating element 448 would be part of a complete electrical circuit. Therefore, only the second resistive heating element 448 would be activated to provide heating.

Similarly, the connector electrical contacts 232 can be control so that only the third and fourth contact pads 460, 462 are electrically connected to the power source 220. In this way, only the third resistive heating element 450 would be part of a complete electrical circuit. Therefore, only the third resistive heating element 450 would be activated to provide heating.

Similarly, the connector electrical contacts 232 can be control so that only the third and fourth contact pad 462, 464 are electrically connected to the power source 220. In this way, only the fourth resistive heating element 452 would be part of a complete electrical circuit. Therefore, only the fourth resistive heating element 452 would be activated to provide heating.

Similarly, the connector electrical contacts 232 can be control so that only the third and fourth contact pad 464, 466 are electrically connected to the power source 220. In this way, only the fifth resistive heating element 454 would be part of a complete electrical circuit. Therefore, only the fifth resistive heating element 454 would be activated to provide heating.

Since the resistive heating elements in the middle share contact pads, the number of contact pads tends to be reduced. Advantageously, the number of electrical contacts for supplying power tends to be reduced while maintaining control over individual activation of each of the resistive heating elements. Since there is no need to switch polarities to activate different resistive heating elements, the control system for individual activation tends to be simplified.

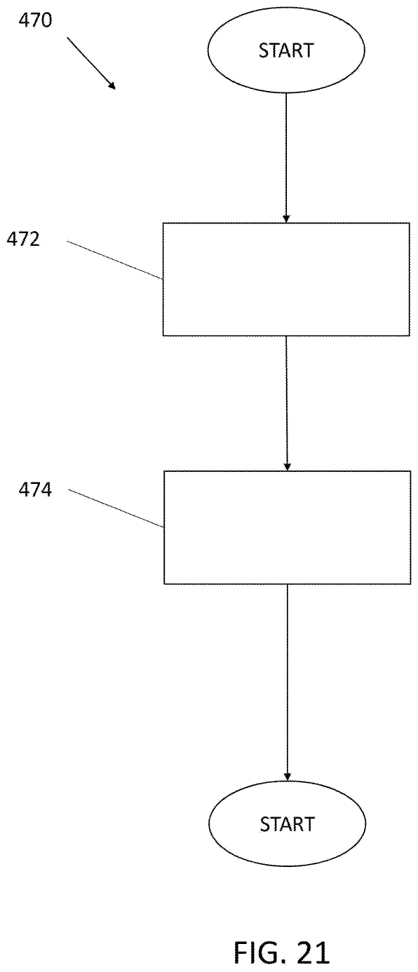

FIG. 21 shows a method 470 of manufacturing an aerosol generator. The method 470 comprises moving 472 a layer of conductive material along a longitudinal direction. This may involve rolling a sheet of aluminium back card material between two rollers. The method 474 further comprises removing conductive material from the layer of the conductive material to form a resistive heating layer, a plurality of a first type of electrical contacts, and at least one second type of electrical contact. The resistive heating layer comprises a first resistive heating element configured to generate heat and a second resistive heating element configured to generate heat. The first resistive heating element is at least a portion of an electrically conductive path between one of the first type of electrical contacts and the or one of the second type of electrical contacts. The second resistive heating element is at least a portion of an electrically conductive path between another one of the first type of electrical contacts and the or another one of the second type of electrical contacts. The first and second resistive heating elements are displaced in a lateral direction perpendicular to the longitudinal direction. In some embodiments, the forming step involves the removal of conductive material may be done by etching (either chemically or by a laser as described above). Additionally or alternatively, the forming step may involve cutting such as die cutting or printing with a resistive ink. In this embodiment, the removal of conductive material is performed at least partially at the same time as the moving the layer of conductive material. In other words, as the sheet of aluminium back card material is rolled into position by the rollers the laser may etch the material at the same time thereby reducing time taken and resources required to manufactured such an aerosol generator.

In some embodiments of the different arrangements of aerosol generators and articles described above the aerosol generating material is formed in a configuration other than as an aerosol generating layer. The aerosol generating material in embodiments is in the form of an aerosol generating segment. The aerosol generating segment generally comprises a solid material. Such a solid material may be shredded tobacco. The aerosol generating material, arranged as an aerosol generating segment for example, may comprise a plurality of individual pieces of aerosol generating material. The aerosol generating material may be individual pieces of tobacco material. In embodiments, the aerosol generating material comprises a plurality of strips, beads or pellets. In embodiments the aerosol generating segment is a plug of material.

The aerosol generating segment in embodiments comprises a body of material. The aerosol generating material is a non-liquid. In such an embodiment, the body of material comprises a rod of aerosol generating material, for example a tobacco rod. For example, the body of material may comprise shredded tobacco material. The body of material may be formed into a rod. In some embodiments, the body of material comprises cut rag tobacco that is formed into a rod. The aerosol generating material may comprise tobacco material. The aerosol generating material may comprise extruded tobacco. The aerosol generating material may comprise reconstituted tobacco.

The aerosol generating material, formed as a solid material, may comprise nicotine. The aerosol generating material may comprises, consist of, or essentially consist of, tobacco. In embodiments, the aerosol generating material is free from tobacco.

In embodiments of any of the above, the heating of the article provides a relatively constant release of volatile compounds into an inhalable medium. In an embodiment of the above, the aerosol generating segment is a plug of material. The article may comprise a mouth end section. A tubular element may be located between the aerosol generating material and the mouth end section. The article may comprise a ventilation area in the mouth end section. The mouth end section may define a mouthpiece configured to be placed between a user's lips.

In embodiments of any of the above described articles, the or each resistive heating element is configured to heat substantially the entire aerosol generating material. The aerosol generating segment in embodiments is at least substantially cylindrical. In embodiments, the aerosol generating segment is at least partially wrapped by the resistive heating layer. In embodiments, the resistive heating element extends in the aerosol generating segment. The resistive heating element may extend around the aerosol generating segment. In embodiments, the resistive heating element encircles the aerosol generating segment. In some arrangements at least a portion of the flow path through the article is through the aerosol generating segment. The aerosol generating segment may define part of the air path. In embodiments, the first type of electrical contact and the second type of electrical contact are exposed from the aerosol generating segment.

The aerosol generating material may comprise tobacco material as described herein, which includes a tobacco component. In the tobacco material described herein, the tobacco component may contain paper reconstituted tobacco. The tobacco component may also contain leaf tobacco, extruded tobacco, and/or bandcast tobacco. The tobacco material may be provided in the form of cut rag tobacco. The cut rag tobacco can be formed from a mixture of forms of tobacco material, for instance a mixture of one or more of paper reconstituted tobacco, leaf tobacco, extruded tobacco and bandcast tobacco. In embodiments, the tobacco material comprises paper reconstituted tobacco or a mixture of paper reconstituted tobacco and leaf tobacco. In the tobacco material described herein, the tobacco material may contain a filler component. The filler component is generally a non-tobacco component, that is, a component that does not include ingredients originating from tobacco. The filler component may be a non-tobacco fibre such as wood fibre or pulp or wheat fibre. The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent. In the tobacco material described herein, the tobacco material contains an aerosol-former material. In this context, an “aerosol-former material” is an agent that promotes the generation of an aerosol. An aerosol-former material may promote the generation of an aerosol by promoting an initial vaporisation and/or the condensation of a gas to an inhalable solid and/or liquid aerosol. In some embodiments, an aerosol-former material may improve the delivery of flavour from the aerosol generating material. In general, any suitable aerosol-former material or agents may be included in the aerosol generating material of the invention, including those described herein.

Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibres) by deposition of the extract onto the fibrous material. The process of recombination resembles the process for making paper. The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol generator of an article for an aerosol provision device, the aerosol generator is elongated along a longitudinal direction, the aerosol generator comprising:
aerosol generating material;
a resistive heating layer comprising:
a first resistive heating element configured to heat at least a first portion of the aerosol generating material to generate an aerosol; and
a second resistive heating element configured to heat at least a second portion of the aerosol generating material to generate another aerosol;
the aerosol generating material being on the resistive heating layer;
at least one first type of electrical contact;
at least one second type of electrical contact;
wherein the first resistive heating element is at least a portion of an electrically conductive path between one of the first type of electrical contact or one of the second type of electrical contact;
wherein the second resistive heating element is at least a portion of an electrically conductive path between another one of the first type of electrical contact or another one of the second type of electrical contact; and
wherein the first resistive heating element is displaced from the second resistive heating element in a lateral direction perpendicular to the longitudinal direction.

2. The aerosol generator of claim 1, wherein the at least one first type of electrical contact is positioned at a longitudinal end of the aerosol generator.

3. The aerosol generator of claim 1, wherein the at least one second type of electrical contact is positioned at a longitudinal end of the aerosol generator.

4. The aerosol generator of claim 1, wherein at least one of the first resistive heating element and second resistive heating element has a serpentine shape.

5. The aerosol generator of claim 1, wherein the first and second resistive heating elements at least partially nest with each other.

6. The aerosol generator of claim 1, wherein the first resistive heating element and the second resistive heating element are interlaced with each other.

7. The aerosol generator of claim 1, wherein the aerosol generator is tubular.

8. The aerosol generator of claim 7, wherein at least one of the first and second resistive heating elements follows a helical path.

9. The aerosol generator of claim 1, further comprising an aerosol generating layer comprising the aerosol generating material, and wherein the aerosol generating layer is on the resistive heating layer.

10. The aerosol generator of claim 1, wherein the first and second resistive heating elements are separate from each other enabling individual activation of each of the first and second resistive heating elements.

11. The aerosol generator of claim 1, wherein the first and second resistive heating elements are directly adjacent to each other.

12. The aerosol generator of claim 1, wherein the at least one second type of electrical contact is a single second type of electrical contact common to both the first and second resistive heating elements.

13. The aerosol generator of claim 1, wherein the at least one second type of electrical contact is a plurality of the second type of electrical contacts.

14. The aerosol generator of claim 1, wherein the first and/or second resistive heating elements extends along a full length of the aerosol generating material in the longitudinal direction.

15. The aerosol generator of claim 1, further comprising a plurality of contact pads comprising:
a first end contact pad electrically coupled to the first type of electrical contact that is closer in a lateral direction to a first longitudinal edge than any of the other first type of electrical contacts;
one or more intermediate contact pads, each of which is electrically coupled to both:
one of the first and second type of electrical contact of one of resistive heating elements, and
one of the first and second type of electric contact of an adjacent resistive heating element; and
a second end contact pad electrically coupled to the second type of electrical contact that is closer in a lateral direction to a second longitudinal edge than any of the other second type of electrical contacts.

16. The aerosol generator of claim 15, wherein each of the one or more intermediate contact pads is electrically coupled to both a first type of electrical contact of one of resistive heating elements and a second type of electric contact of an adjacent resistive heating element.

17. The aerosol generator of claim 15, wherein each of the one or more intermediate contact pads is electrically coupled to both a first type of electrical contact of one of resistive heating elements and a first type of electric contact of an adjacent resistive heating element.

18. The aerosol generator of claim 1, wherein each of the second type of electrical contacts is positioned between two first type of electrical contacts; and/or
each of the first type of electrical contacts is positioned between two second type of electrical contacts.

19. (canceled)

20. (canceled)

21. An aerosol generator of an article for an aerosol provision device, the aerosol generator is elongated along a longitudinal direction, the aerosol generator comprising:
aerosol generating material;
a resistive heating layer comprising a resistive heating element configured to heat at least a portion of the aerosol generating material to generate an aerosol;
the aerosol generating material being on the resistive heating layer;
a first type of electrical contact; and
a second type of electrical contact;
wherein the resistive heating element is at least a portion of an electrically conductive path between the first type of electrical contact and the second type of electrical contact; and
wherein the resistive heating element extends along a full length of a heating section of the aerosol generator in the longitudinal direction.

22. An aerosol generator of an article for an aerosol provision device, the aerosol generator is elongated along a longitudinal direction, the aerosol generator comprising:
aerosol generating material;
a resistive heating layer comprising a resistive heating element configured to heat at least a portion of the aerosol generating material to generate an aerosol;
the aerosol generating material being on the resistive heating layer;
a first type of electrical contact; and
a second type of electrical contact;
wherein the resistive heating element is at least a portion of an electrically conductive path between the first type of electrical contact and the second type of electrical contact; and
wherein the electrically conductive path extends back and forth along the longitudinal direction.

23. (canceled)

24. (canceled)
